(19) United States
(12) Patent Application Publication
(10) Pub. No.: US 2025/0385978 A1
(43) Pub. Date: Dec. 18, 2025

(54) IMAGE READING DEVICE

(71) Applicant: Foxlink Image Technology Co., Ltd., New Taipei City (TW)

(72) Inventors: Chien Hui Lee, New Taipei City (TW); Pai Hsien Su, New Taipei City (TW); Wen Yu Wang, New Taipei City (TW)

(21) Appl. No.: 18/948,804

(22) Filed: Nov. 15, 2024

(30) Foreign Application Priority Data
Jun. 13, 2024 (CN) 202421352104.4

(51) Int. Cl. H04N 1/00

(52) U.S. Cl. CPC H04N 1/00602

(57) ABSTRACT

An image reading device includes a first frame, a second frame disposed to a top of the first frame, a first active roller rotatably disposed to the first frame, a second active roller rotatably disposed to the first frame, a first driven roller rotatably disposed to the second frame, a second driven roller rotatably disposed to the second frame, a driving unit, an active transmission mechanism, a driven transmission mechanism and a reading unit. The driving unit outputs a driving force. The active transmission mechanism is connected between the first active roller and the second active roller. The driven transmission mechanism is connected between the first driven roller and the second driven roller. The reading unit is set to read an image on an image medium transmitted by the first active roller and the second active roller which rotate together.

### CROSS REFERENCE TO RELATED APPLICATIONS

The present application is based on, and claims priority from, China Patent Application No. 202421352104.4, filed Jun. 13, 2024, the disclosure of which is hereby incorporated by reference herein in its entirety.

### BACKGROUND OF THE INVENTION

### Field of the Invention

The present invention generally relates to an image reading device, and more particularly to an image reading device which has a simplified structure and is able to feed image media at a constant speed.

### Description of Related Art

Generally, a common image reading device is equipped with a paper feeding structure for automatically feeding image media, such as paper. A common paper feeding structure includes a feeding path, an image scanning unit disposed in the feeding path, and two paper feeding roller modules positioned to an upstream and a downstream of the image scanning unit, respectively.

In order to ensure that the image reading device correctly read both thin documents and thicker bound booklets. Each paper feeding roller module is equipped with a feeding roller and a movable pressure roller. Nonetheless, when the image media passes the movable pressure roller of each paper feeding roller module, the image media is easily affected to have no way of passing through the movable pressure roller at a constant speed, so that a skew or a jitter of a scanned image. Thus, in order to improve a stability of the paper feeding roller module at the time of feeding the image media and to reduce the jitter of the scanned image, both the paper feeding roller and the pressure roller are connected to a drive motor to rotate actively so as to ensure that the image media passes at the constant speed.

However, in order to connect the paper feeding rollers and the movable pressure rollers of the two paper feeding roller modules to the drive motor for rotating actively, an overall transmission system of the image reading device is set to be more complex.

Therefore, it is necessary to provide an image reading device which has a simplified structure and is able to feed the image media at the constant speed.

### BRIEF SUMMARY OF THE INVENTION

An object of the present invention is to provide an image reading device which has a simplified structure and is able to feed image media at a constant speed. The image reading device includes a first frame, a second frame disposed to a top of the first frame, a first active roller rotatably disposed to the first frame, a second active roller rotatably disposed to the first frame, a first driven roller rotatably disposed to the second frame, a second driven roller rotatably disposed to the second frame, a driving unit, an active transmission mechanism, a driven transmission mechanism and a reading unit. The first driven roller which is rotatably disposed to the second frame is translatable. The second driven roller which is rotatably disposed to the second frame is translatable. The driving unit outputs a driving force to the first active roller. The active transmission mechanism is connected between the first active roller and the second active roller to output the driving force to the second active roller. The driven transmission mechanism is connected between the first driven roller and the second driven roller to synchronize a rotation speed of the first driven roller and a rotation speed of the second driven roller. The reading unit is set to read an image on an image medium transmitted by the first active roller and the second active roller which rotate together. The first driven roller and the second driven roller are respectively pressed against the first active roller and the second active roller.

Another object of the present invention is to provide an image reading device. The image reading device includes a first frame, a second frame disposed to a top of the first frame, a first active roller rotatably disposed to the first frame, a second active roller rotatably disposed to the first frame, a third active roller rotatably disposed to the first frame, a first driven roller rotatably disposed to the second frame, a second driven roller rotatably disposed to the second frame, a third driven roller rotatably disposed to the second frame, a driving unit, an active transmission mechanism, a driven transmission mechanism and a reading unit. The first driven roller which is rotatably disposed to the second frame is translatable. The second driven roller which is rotatably disposed to the second frame is translatable. The third driven roller which is rotatably disposed to the second frame is translatable. The driving unit is set to output a driving force. The active transmission mechanism is rotatably connected to the driving unit. The active transmission mechanism is connected among the first active roller, the second active roller and the third active roller to output the driving force to the first active roller, the second active roller and the third active roller. The driven transmission mechanism is connected among the first driven roller, the second driven roller and the third driven roller to synchronize a rotation speed of the first driven roller, a rotation speed of the second driven roller and a rotation speed of the third driven roller. The reading unit is set to read an image on an image medium transmitted by the first active roller and the second active roller which rotate together. The first driven roller, the second driven roller and the third driven roller are pressed against the first active roller, the second active roller and the third active roller.

Another object of the present invention is to provide an image reading device. The image reading device includes a frame, a first active roller rotatably mounted to the frame, a second active roller rotatably mounted to the frame, a third active roller rotatably mounted to the frame, a first driven roller mounted to the frame, a second driven roller mounted to the frame, a third driven roller mounted to the frame, a driving unit set to output a driving force, an active transmission mechanism, a driven transmission mechanism and a reading unit. The first driven roller is rotatable and translational. The second driven roller is rotatable and translational. The third driven roller is rotatable and translational. The active transmission mechanism is connected among the first active roller, the second active roller and the third active roller to output the driving force to the first active roller, the second active roller and the third active roller. The driven transmission mechanism is connected among the first driven roller, the second driven roller and the third driven roller to synchronize a rotation speed of the first driven roller, a rotation speed of the second driven roller and a rotation speed of the third driven roller. The reading unit is set to read an image on an image medium transmitted by the first active roller and the second active roller which rotate together. The first driven roller, the second driven roller and the third driven roller are pressed against the first active roller, the second active roller and the third active roller.

As described above, the image reading device includes the frame, the first active roller, the second active roller, the first driven roller, the second driven roller, the driving unit outputting the driving force to the first active roller, the active transmission mechanism connected between the first active roller and the second active roller to transmit the driving force to the second active roller, and the driven transmission mechanism connected between the first driven roller and the second driven roller to synchronize the rotation speed of the first driven roller and the rotation speed of the second driven roller. Moreover, the rotation speeds of the first driven roller and the second driven roller maintain the same as the rotation speeds of the first active roller and the second active roller through the driven transmission mechanism. As a result, the image reading device has a simplified structure and is able to feed the image media at the constant speed.

### BRIEF DESCRIPTION OF THE DRAWINGS

The present invention will be apparent to those skilled in the art by reading the following description, with reference to the attached drawings, in which:

FIG. 1 is a sectional view of an image reading device according to the present invention;

FIG. 2 is a partially perspective view of the image reading device according to the present invention;

FIG. 3 is a partial side view of the image reading device, wherein at least one active roller and at least one driven roller feed paper;

FIG. 4 is another partial side view of the image reading device, wherein the at least one active roller and the at least one driven roller feed a booklet;

FIG. 5 is a partial assembling view of the image reading device, wherein the at least one active roller is assembled with a driving unit and an active transmission mechanism according to the present invention; and

FIG. 6 is another partial assembling view of the image reading device, wherein the at least one driven roller is assembled with two elastic supporting mechanisms, a driven transmission mechanism, a first coupling and a second coupling according to the present invention.

### DETAILED DESCRIPTION OF THE INVENTION

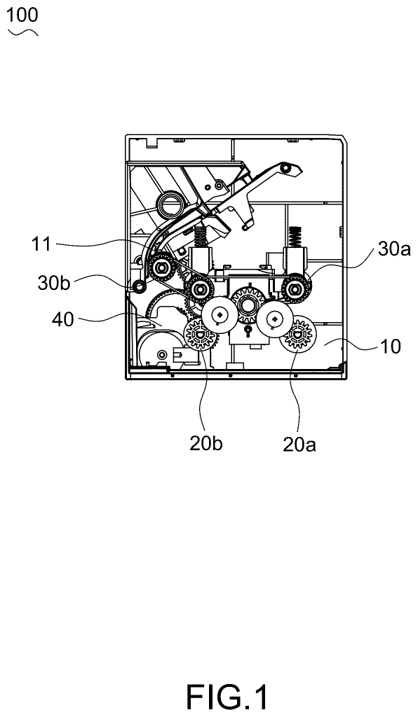

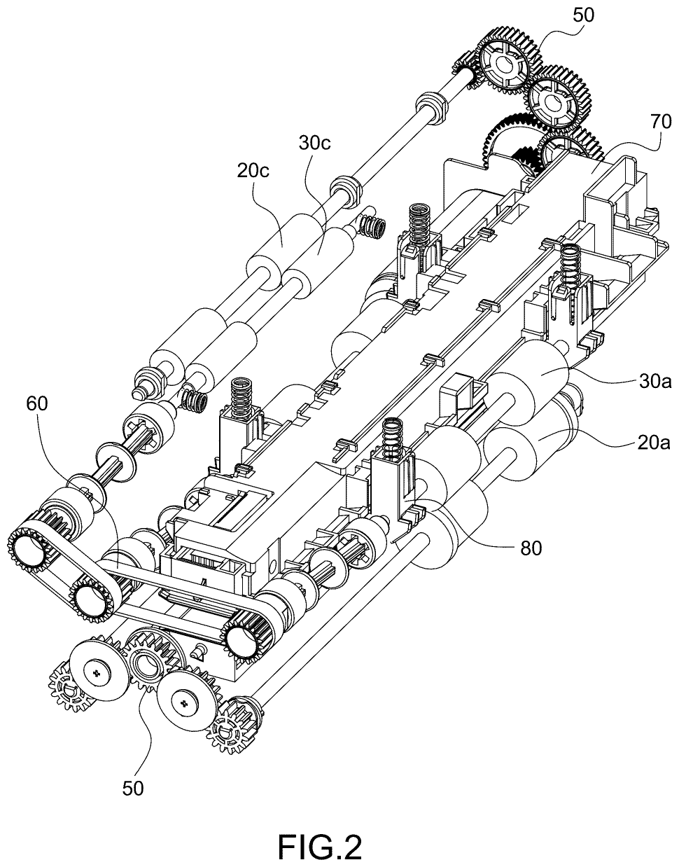

Referring to FIG. 1 and FIG. 2, an image reading device 100 according to the present invention is shown. The image reading device 100 includes a frame 10, and a feeding path 11 passing through the frame 10. the frame 10

The image reading device 100 includes a first active roller 20a, a second active roller 20b and a third active roller 20c. The first active roller 20a is rotatably disposed to the frame 10. The second active roller 20b is rotatably disposed to the frame 10. The third active roller 20c is rotatably disposed to the frame 10. The frame 10 is equipped with the first active roller 20a, the second active roller 20b and the third active roller 20c. The first active roller 20a, the second active roller 20b and the third active roller 20c are all rotatably mounted to the frame 10, and the first active roller 20a, the second active roller 20b and the third active roller 20c are partially positioned in the feeding path 11 to feed image media, such as paper or booklets.

The image reading device 100 includes a first driven roller 30a, a second driven roller 30b and a third driven roller 30c. The first driven roller 30a is rotatably disposed to the frame 10. The first driven roller 30a which is rotatably disposed to the frame 10 is translatable. The second driven roller 30b is rotatably disposed to the frame 10. The second driven roller 30b which is rotatably disposed to the frame 10 is translatable. The frame 10 is also equipped with the first driven roller 30a, the second driven roller 30b and the third driven roller 30c. The first driven roller 30a, the second driven roller 30b and the third driven roller 30c are mounted to the frame 10. The first driven roller 30a, the second driven roller 30b and the third driven roller 30c are rotatable and translational. The first driven roller 30a, the second driven roller 30b and the third driven roller 30c are aligned with the first active roller 20a, the second active roller 20b and the third active roller 20c, so that when an image medium is fed, the image medium is pressed against the first active roller 20a, the second active roller 20b and the third active roller 20c.

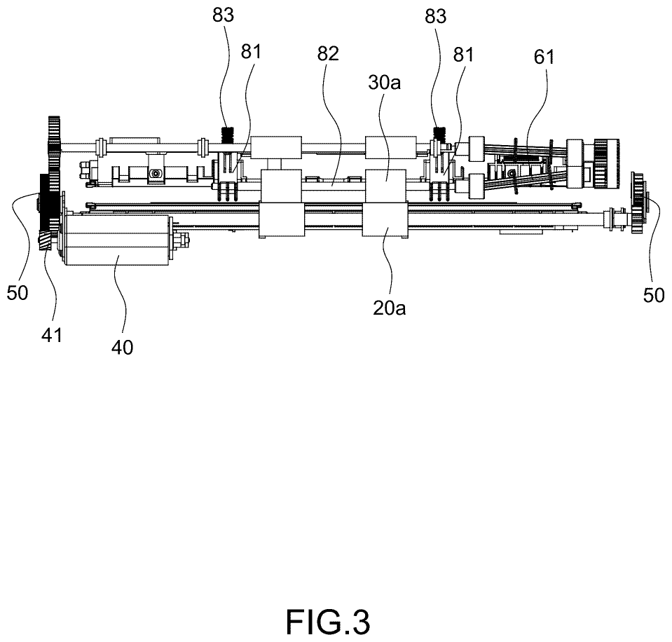

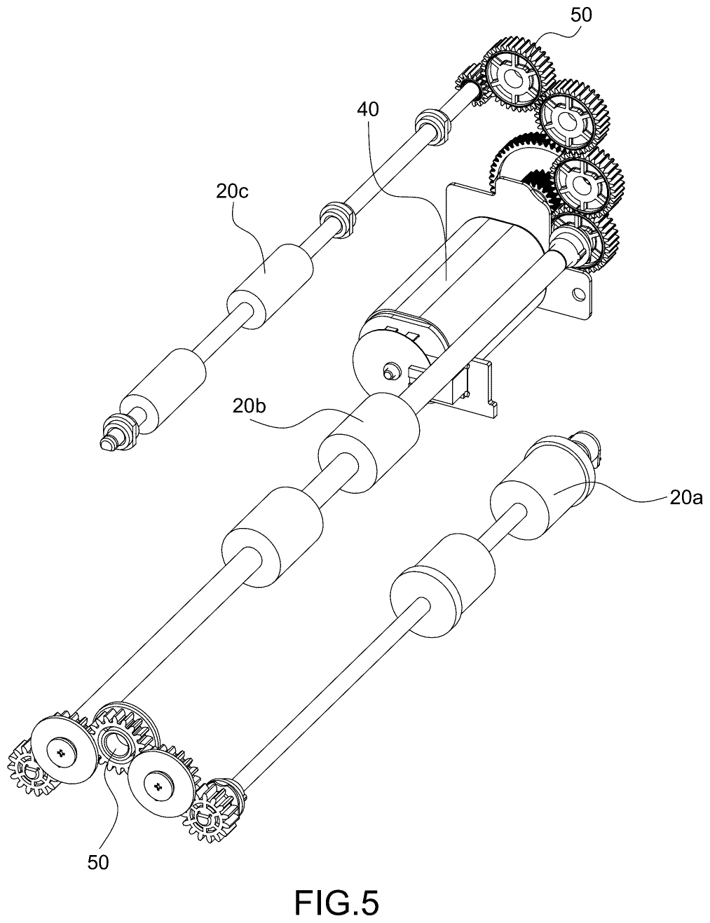

Referring to FIG. 1, FIG. 2, FIG. 3 and FIG. 5, the image reading device 100 includes a driving unit 40. The driving unit 40 is mounted in the frame 10. The driving unit 40 is set to output a driving force. The driving unit 40 outputs the driving force to the first active roller 20a. The driving unit 40 includes an active driving mechanism 41. One end of the active driving mechanism 41 is connected to the driving unit 40. The other end of the active driving mechanism 41 is connected to the first active roller 20a, the second active roller 20b and the third active roller 20c to evenly output the driving force to the first active roller 20a, the second active roller 20b and the third active roller 20c. The active driving mechanism 41 is designed as a gear assembly which is formed by assembling a plurality of gears. The active driving mechanism 41 of the driving unit 40 transmits the driving force with the same direction and the same rotation speed to the first active roller 20a, the second active roller 20b and the third active roller 20c.

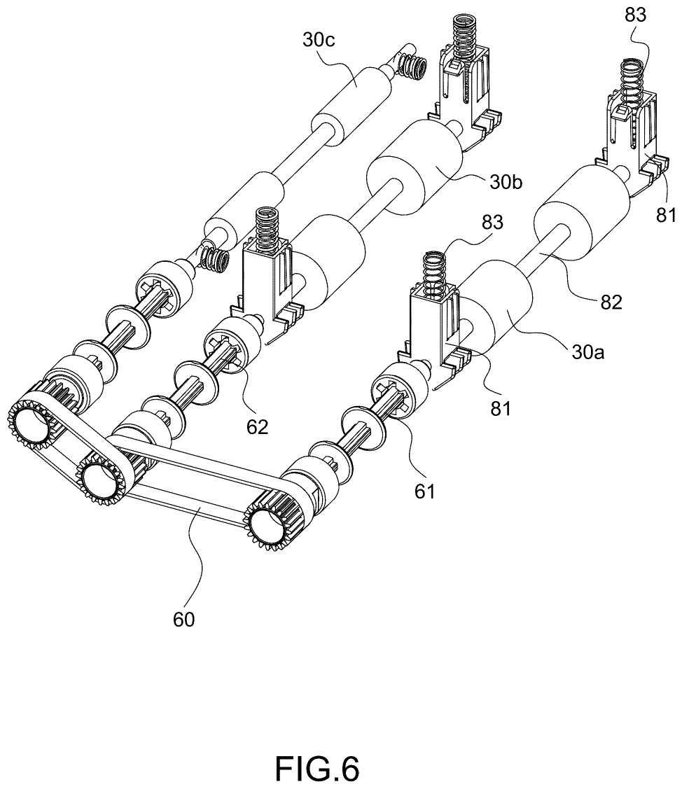

Referring to FIG. 1, FIG. 2, FIG. 5 and FIG. 6, the image reading device 100 includes an active transmission mechanism 50 and a driven transmission mechanism 60. The active transmission mechanism 50 is disposed in the frame 10. The active transmission mechanism 50 is rotatably connected to the driving unit 40. The active transmission mechanism 50 is connected between the first active roller 20a and the second active roller 20b to output the driving force to the second active roller 20b. The active transmission mechanism 50 is connected among the first active roller 20a, the second active roller 20b and the third active roller 20c to output the driving force to the first active roller 20a, the second active roller 20b and the third active roller 20c. The third active roller 20c is connected to the driving unit 40 via the active transmission mechanism 50.

The driven transmission mechanism 60 is connected among the first driven roller 30a, the second driven roller 30b and the third driven roller 30c to synchronize a rotation speed of the first driven roller 30a, a rotation speed of the second driven roller 30b and a rotation speed of the third driven roller 30c. The third driven roller 30c is rotatably disposed to the frame 10. The third driven roller 30c which is rotatably disposed to the frame 10 is translatable.

The driven transmission mechanism 60 is designed as a plurality of transmission belts. Two ends of the driven transmission mechanism 60 are assembled among the first driven roller 30a, the second driven roller 30b and the third driven roller 30c. The transmission belts ensure that the first driven roller 30a, the second driven roller 30b and the third driven roller 30c all rotate at the same speed. Additionally, each of an upper side and a lower side of the feeding path 11 is provided with a reading unit 70. The reading unit 70 is set to read an image on the image medium transmitted by the first active roller 20a and the second active roller 20b which rotate together. The first driven roller 30a and the second driven roller 30b are respectively pressed against the first active roller 20a and the second active roller 20b. The first driven roller 30a, the second driven roller 30b and the third driven roller 30c are pressed against the first active roller 20a, the second active roller 20b and the third active roller 20c.

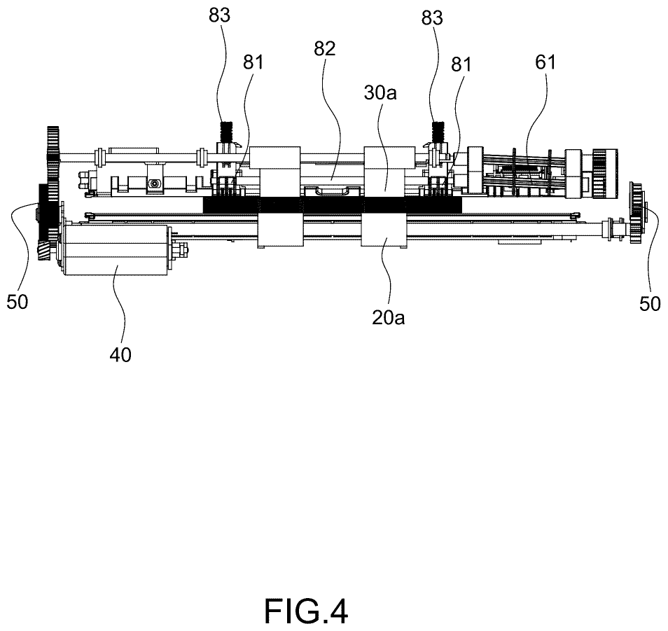

Referring to FIG. 1 to FIG. 4, the first driven roller 30a, the second driven roller 30b and the third driven roller 30c are equipped in the image reading device 100. The first driven roller 30a, the second driven roller 30b and the third driven roller 30c are translatable and rotatable with respect to the frame 10 to ensure that the image reading device 100 is able to be appropriate for the image media with various different thicknesses. The active transmission mechanism 50 keeps the first driven roller 30a, the second driven roller 30b and the third driven roller 30c rotate at the same rotation speed.

The first driven roller 30a, the second driven roller 30b and the third driven roller 30c are positioned from an upstream of the feeding path 11 to a downstream of the feeding path 11. When the image media is fed through the feeding path 11, at least one driven roller and at least one corresponding active roller are unblocked by the image media, the at least one driven roller and the at least one corresponding active roller keep a contacting status, so that the at least one driven roller and the at least one corresponding active roller rotate at the same rotation speed to ensure that the at least one driven roller and the at least one corresponding active roller maintain a steady and consistent speed at the time of feeding the image media. The at least one active roller includes the first active roller 20a, the second active roller 20b and the third active roller 20c. The at least one driven roller includes the first driven roller 30a, the second driven roller 30b and the third driven roller 30c.

When the image media is fed through the feeding path 11, at least one of the first driven roller 30a, the second driven roller 30b and the third driven roller 30c and at least one of the first active roller 20a, the second active roller 20b and the third active roller 20c are unblocked by the image media, and the at least one of the first driven roller 30a, the second driven roller 30b and the third driven roller 30c and the at least one of the first active roller 20a, the second active roller 20b and the third active roller 20c keep a contacting state, so that the first driven roller 30a, the second driven roller 30b, the third driven roller 30c, the first active roller 20a, the second active roller 20b and the third active roller 20c rotate at the same rotation speed to ensure that the first driven roller 30a, the second driven roller 30b, the third driven roller 30c, the first active roller 20a, the second active roller 20b and the third active roller 20c maintain the steady and consistent speed at the time of feeding the image media. Thus, a skew or a jitter of the scanned image is prevented.

Referring to FIG. 2, FIG. 3 and FIG. 6, in order to allow the first driven roller 30a and the second driven roller 30b to translate and rotate simultaneously relative to the frame 10, the image reading device 100 further includes a first coupling 61 connected between the driven transmission mechanism 60 and the first driven roller 30a, and a second coupling 62 connected between the driven transmission mechanism 60 and the second driven roller 30b. The driven transmission mechanism 60 is connected between the first driven roller 30a and the second driven roller 30b to synchronize the rotation speed of the first driven roller 30a and the rotation speed of the second driven roller 30b. The first coupling 61 and the second coupling 62 are set as flexible couplings.

The first driven roller 30a and the second driven roller 30b are fastened to the frame 10 via two clastic supporting mechanisms 80, respectively. Each elastic supporting mechanism 80 includes a plurality of slide rail brackets 81 which are movably mounted to the frame 10, a roller shaft 82 mounted to the plurality of the slide rail brackets 81 and moving with the plurality of the slide rail brackets 81, and a plurality of bracket springs 83 arranged between the frame 10 and the plurality of the slide rail brackets 81 to push the plurality of the slide rail brackets 81 towards a direction of the first active roller 20a and the second active roller 20b. The third driven roller 30c is connected to the driven transmission mechanism 60 to synchronize the rotation speed of the third driven roller 30c with the rotation speeds of the first driven roller 30a and the second driven roller 30b.

As described above, the image reading device 100 includes the frame 10, the first active roller 20a, the second active roller 20b, the first driven roller 30a, the second driven roller 30b, the driving unit 40 outputting the driving force to the first active roller 20a, the active transmission mechanism 50 connected between the first active roller 20a and the second active roller 20b to transmit the driving force to the second active roller 20b, and the driven transmission mechanism 60 connected between the first driven roller 30a and the second driven roller 30b to synchronize the rotation speed of the first driven roller 30a and the rotation speed of the second driven roller 30b. Moreover, the rotation speeds of the first driven roller 30a and the second driven roller 30b maintain the same as the rotation speeds of the first active roller 20a and the second active roller 20b through the driven transmission mechanism 60. As a result, the image reading device 100 has a simplified structure and is able to feed the image media at the constant speed.

What is claimed is:

1. An image reading device, comprising:
a first frame;
a second frame disposed to a top of the first frame;
a first active roller rotatably disposed to the first frame;
a second active roller rotatably disposed to the first frame;
a first driven roller rotatably disposed to the second frame, the first driven roller which is rotatably disposed to the second frame being translatable;
a second driven roller rotatably disposed to the second frame, the second driven roller which is rotatably disposed to the second frame being translatable;
a driving unit outputting a driving force to the first active roller;
an active transmission mechanism connected between the first active roller and the second active roller to output the driving force to the second active roller;
a driven transmission mechanism connected between the first driven roller and the second driven roller to synchronize a rotation speed of the first driven roller and a rotation speed of the second driven roller; and
a reading unit set to read an image on an image medium transmitted by the first active roller and the second active roller which rotate together,
wherein the first driven roller and the second driven roller are respectively pressed against the first active roller and the second active roller.

2. The image reading device as claimed in claim 1, further comprising a first coupling connected between the driven transmission mechanism and the first driven roller, and a second coupling connected between the driven transmission mechanism and the second driven roller.

3. The image reading device as claimed in claim 2, wherein the first coupling and the second coupling are set as flexible couplings.

4. The image reading device as claimed in claim 1, wherein the image reading device includes a frame, the frame includes the first frame and the second frame, the first driven roller and the second driven roller are fastened to the frame via two elastic supporting mechanisms, respectively, each elastic supporting mechanism includes a plurality of slide rail brackets which are movably mounted to the frame, a roller shaft mounted to the plurality of the slide rail brackets and moving with the plurality of the slide rail brackets, and a plurality of bracket springs arranged between the frame and the plurality of the slide rail brackets to push the plurality of the slide rail brackets towards a direction of the first active roller and the second active roller.

5. The image reading device as claimed in claim 1, wherein the image reading device further includes a third active roller rotatably disposed to the first frame of the frame, a third driven roller rotatably disposed to the second frame of the frame, the third driven roller which is rotatably disposed to the second frame is translatable, the third active roller is connected to the driving unit via the active transmission mechanism, the third driven roller is connected to the driven transmission mechanism to synchronize a rotation speed of the third driven roller with the rotation speeds of the first driven roller and the second driven roller.

6. The image reading device as claimed in claim 1, wherein the driven transmission mechanism is designed as a plurality of transmission belts.

7. An image reading device, comprising:
a first frame;
a second frame disposed to a top of the first frame;
a first active roller rotatably disposed to the first frame;
a second active roller rotatably disposed to the first frame;
a third active roller rotatably disposed to the first frame;
a first driven roller rotatably disposed to the second frame, the first driven roller which is rotatably disposed to the second frame being translatable;
a second driven roller rotatably disposed to the second frame, the second driven roller which is rotatably disposed to the second frame being translatable;
a third driven roller rotatably disposed to the second frame, the third driven roller which is rotatably disposed to the second frame being translatable;
a driving unit set to output a driving force;
an active transmission mechanism rotatably connected to the driving unit, the active transmission mechanism connected among the first active roller, the second active roller and the third active roller to output the driving force to the first active roller, the second active roller and the third active roller;
a driven transmission mechanism connected among the first driven roller, the second driven roller and the third driven roller to synchronize a rotation speed of the first driven roller, a rotation speed of the second driven roller and a rotation speed of the third driven roller; and
a reading unit set to read an image on an image medium transmitted by the first active roller and the second active roller which rotate together,
wherein the first driven roller, the second driven roller and the third driven roller are pressed against the first active roller, the second active roller and the third active roller.

8. An image reading device, comprising:
a frame;
a first active roller rotatably mounted to the frame;
a second active roller rotatably mounted to the frame;
a third active roller rotatably mounted to the frame;
a first driven roller mounted to the frame, the first driven roller being rotatable and translational;
a second driven roller mounted to the frame, the second driven roller being rotatable and translational;
a third driven roller mounted to the frame, the third driven roller being rotatable and translational;
a driving unit set to output a driving force;
an active transmission mechanism connected among the first active roller, the second active roller and the third active roller to output the driving force to the first active roller, the second active roller and the third active roller;
a driven transmission mechanism connected among the first driven roller, the second driven roller and the third driven roller to synchronize a rotation speed of the first driven roller, a rotation speed of the second driven roller and a rotation speed of the third driven roller; and
a reading unit set to read an image on an image medium transmitted by the first active roller and the second active roller which rotate together,
wherein the first driven roller, the second driven roller and the third driven roller are pressed against the first active roller, the second active roller and the third active roller.
